(19) United States
(12) Patent Application Publication
(10) Pub. No.: US 2011/0319132 A1
(43) Pub. Date: Dec. 29, 2011

(54) MOBILE PHONE HAVING DETACHABLE SMART CARD MODULE

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/831,378

(22) Filed: Jul. 7, 2010

(30) Foreign Application Priority Data
Jun. 23, 2010 (TW) 99120505

(51) Int. Cl. H04M 1/00

(52) U.S. Cl. 455/558

(57) ABSTRACT

A mobile phone includes a mobile phone main module and a smart card module. The mobile phone main module includes a smart card reading circuit and a first universal serial bus (USB) port connected to the smart card reading circuit. The smart card module includes a smart card holder having a smart card and a USB plug connected to the smart card holder. The smart card reading circuit communicates with the smart card in response to the USB plug being inserted in the first USB port. The smart card module is also operable to be used for a computer in response to the USB plug being inserted in a USB port of the computer.

### BACKGROUND

1. Technical Field

The present disclosure relates to a mobile phone.

2. Description of Related Art

Nowadays, some computers can connect, using various methods, with external wireless networks by using smart cards, such as subscriber identity module (SIM) cards. One method is to connect a computer to a mobile phone via a cable, and then the computer reads a smart card of the mobile phone and uses it to access the Internet. A second method is to take the smart card out of the mobile phone, and insert the smart card in the computer. Then, the computer can directly read the smart card and use it to access the Internet.

However, the first method requires the mobile phone to be on all the time the computer uses the smart card to access the Internet, which wastes electricity and shortens the lifespan of the mobile phone battery. The second method requires opening up the mobile phone to get the smart card, and put the smart card in the computer, which is inconvenient and may cause excess wear and tear to the mobile phone over time.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mobile phone including a smart card module.

FIG. 2 is an assembled view of the mobile phone of FIG. 1.

FIG. 3 is a partial circuit diagram of the mobile phone of FIG. 1.

FIG. 4 is a schematic view of a computer and the smart card module of FIG. 1.

### DETAILED DESCRIPTION

The disclosure, including the accompanying drawing in which like references indicate similar elements, is illustrated by way of example and not by way of limitation. It should be noted that references to “an” or “one” embodiment in this disclosure are not necessarily to the same embodiment, and such references mean at least one.

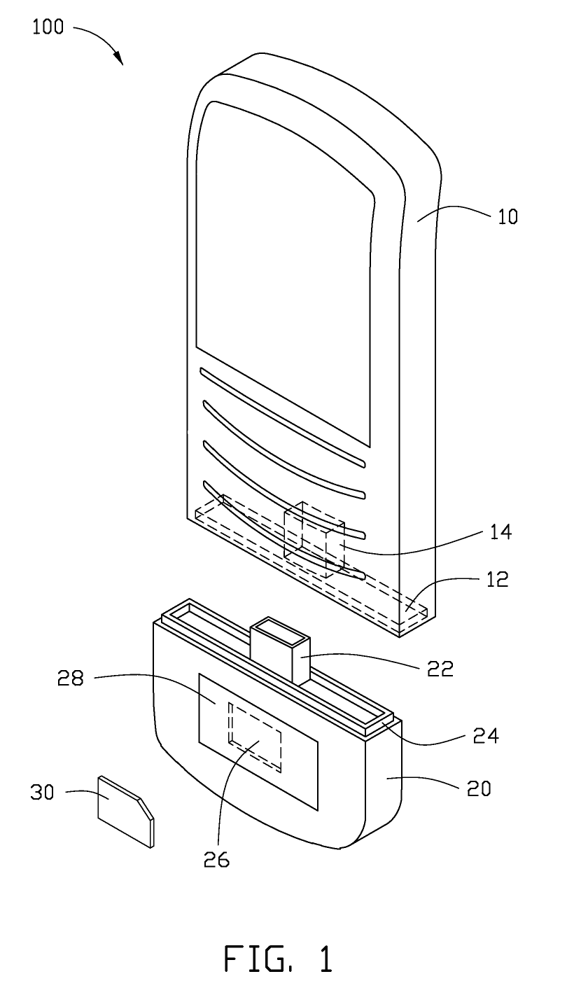

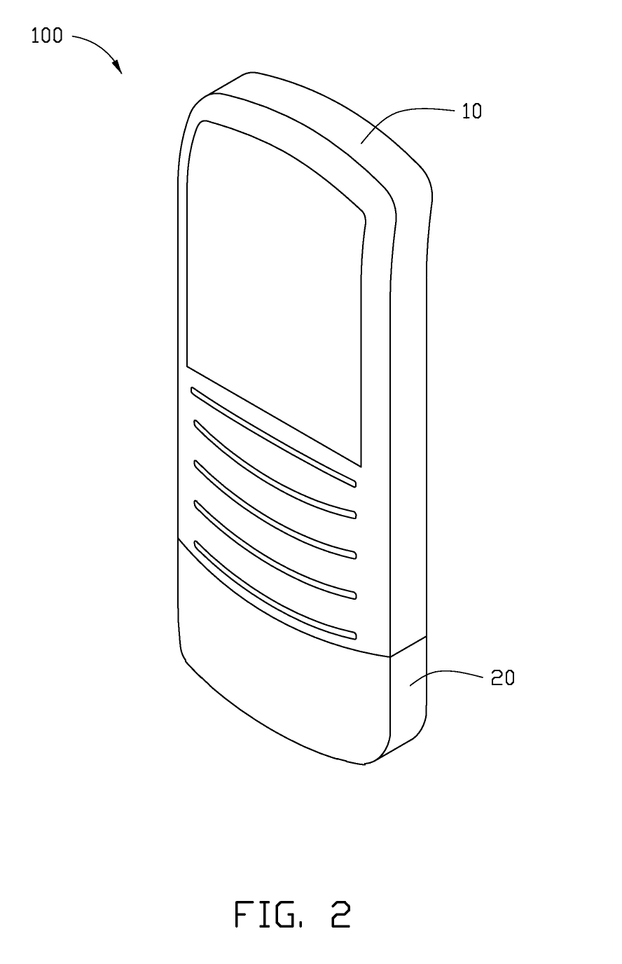

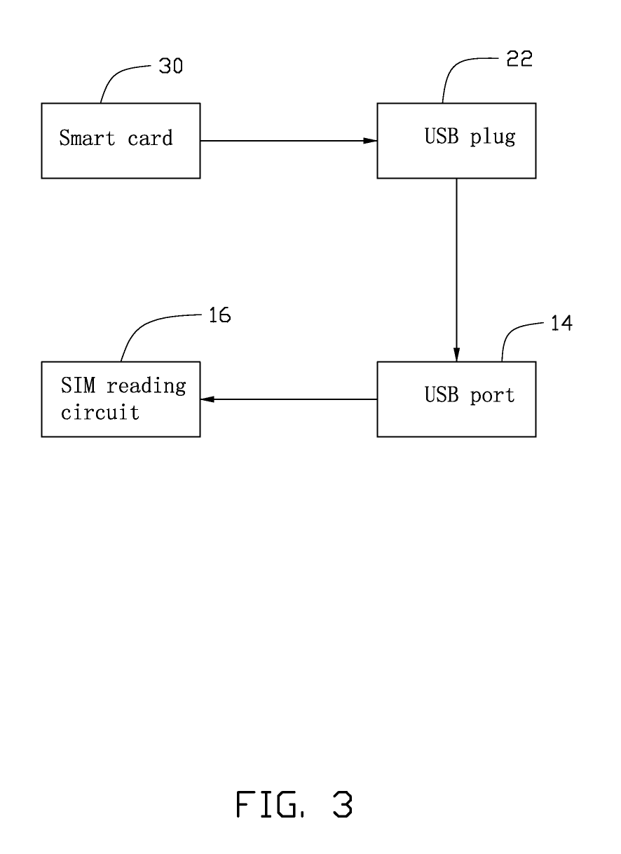

Referring to FIGS. 1 to 3, an embodiment of a mobile phone 100 includes a mobile phone main module 10 and a smart card module 20. It may be understood that the mobile phone main module 10 includes all circuits of a common mobile phone, such as a process unit, and a display circuit, etc. These circuits fall within well-known technologies, and are therefore not described here.

The smart card module 20 includes a smart card holder 26 for installing a smart card 30. The smart card holder 26 is defined in a side surface of the smart card module 20, and a cover 28 is attached to the side surface to cover the smart card 30. The smart card module 20 further includes a universal serial bus (USB) plug 22 extending from one side of the smart card module 20. The USB plug 22 is connected to the smart card holder 26. A rectangular positioning wall 24 extends from the same side of the smart card module 20 as the USB plug 22.

The mobile phone main module 10 includes a smart card reading circuit 16 and a USB port 14 connected to the smart card reading circuit 16. The USB port 14 is defined in the mobile phone main module 10. The mobile phone main module 10 also defines a groove 12 corresponding to the positioning wall 24 of the smart card module 20. When the USB plug 22 is inserted into the USB port 14, the positioning wall 24 is received in the groove 12 with a friction fit to maintain the smart card module 20 on the mobile phone main module 10. Side surfaces of the smart card module 20 may be shaped to be complementary to the shape of the mobile phone main module 10 when engaged with the mobile phone main module 10.

When the USB plug 22 is inserted in the USB port 14 and the smart card 30 is inserted in the smart card holder 26, the smart card reading circuit 16 can read the smart card 30, therefore the mobile phone can work normally.

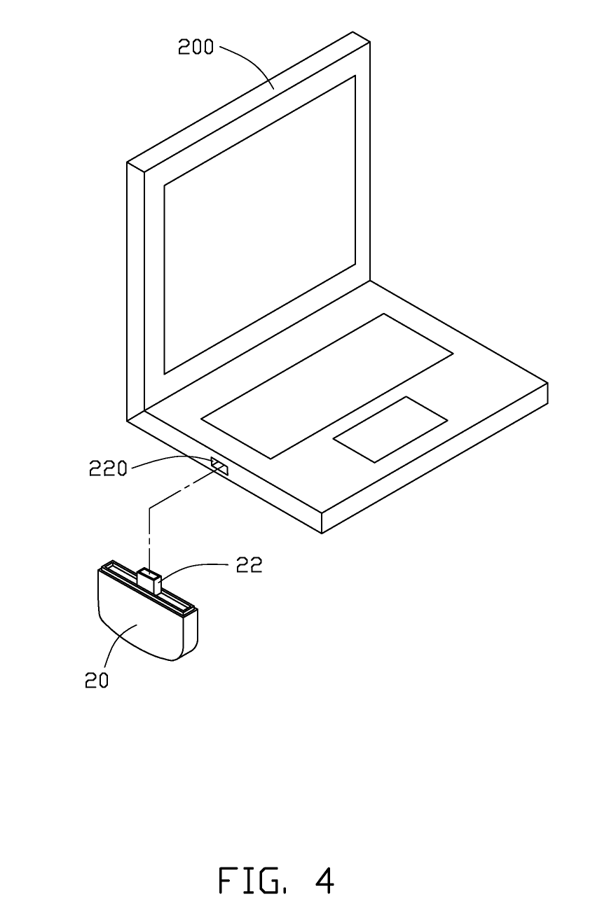

Referring to FIG. 4, when a computer 200 needs to use the smart card 30 to access the Internet, the smart card module 20 is pulled out from the mobile phone main module 10. The USB plug 22 is inserted in a USB port 220 of the computer 200, and then the computer 200 can read the smart card 30 via the smart card module 20 to access the Internet, which is very convenient and cannot wear and tear the mobile phone 100.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mobile phone comprising:
a mobile phone main module comprising a smart card reading circuit and a first universal serial bus (USB) port connected to the smart card reading circuit; and
a smart card module comprising a smart card holder having a smart card, and a USB plug connected to the smart card holder;
wherein the smart card reading circuit communicates with the smart card in response to the USB plug being inserted in the first USB port; and
wherein the smart card module is also operable to be used for a computer in response to the USB plug being inserted in a second USB port of the computer.

2. The mobile phone of claim 1, wherein a rectangular positioning wall extends from the same side of the smart card module as the USB plug, the mobile phone main module defines a groove corresponding to the positioning wall of the smart card module, and the positioning wall is received in the groove with a friction fit to maintain the smart card module on the mobile phone main module in response to the USB plug being inserted in the first USB port.

3. The mobile phone of claim 1, wherein the smart card holder is defined in a side surface of the smart card module, and a cover is attached to the side surface to cover the Smart card.

4. The mobile phone of claim 1, wherein side surfaces of the smart card module are shaped to be complementary to the shape of the mobile phone main module when engaged with the mobile phone main module.

5. A mobile phone comprising:
a main module; and
a detachable module connected to the main module via a universal serial bus (USB) port; the detachable module comprises a smart card reader;
wherein when a smart card is inserted in the smart card reader the mobile phone functions as a regular mobile phone; and
wherein when the detachable module with the smart card inserted in the smart card reader is detached from the main module and inserted in a USB port of a computer, the computer is able to perform certain functions of a regular mobile phone.
